(19) United States
(12) Patent Application Publication
(10) Pub. No.: US 2022/0011072 A1
(43) Pub. Date: Jan. 13, 2022

(54) Pressure sensing loading rod for Muzzle Loading rifles

(71) Applicant: John Minnich, Woodinville, WA (US)

(72) Inventor: John Minnich, Woodinville, WA (US)

(21) Appl. No.: 16/948,133

(22) Filed: Sep. 3, 2020

Related U.S. Application Data
(60) Provisional application No. 62/705,601, filed on Jul. 7, 2020.

(51) Int. Cl. F41C 9/08; G01L 5/00

(52) U.S. Cl. CPC F41C 9/085; G01L 5/0038

(57) ABSTRACT

A force measuring device for a muzzle loader.

This application claims priority to provisional application No. 62/705,601, filed Jul. 7, 2020, the entire contents of which are herewith incorporated by reference.

### BACKGROUND

Muzzle loading rifles are conventionally loaded using a solid loading rod (also known as a “ram rod”) which seats a bullet on top of a powder charge inside the muzzle. Solid loading rods are manufactured from either a single piece rod, or multiple sections that screw together. Materials vary but most common include wood, fiberglass, carbon fiber, aluminum, or steel.

Solid loading rods have a knob or “T” handle at one end that the person loading the rifle presses on to compress the bullet against the powder charge inside the rifle.

### SUMMARY OF THE INVENTION

The inventor recognized, however, that there are a number of drawbacks with the current systems.

The inventor recognizes that the accuracy of a muzzle loading rifle is based on an amount of and/or consistency of compression of the bullet/powder. Yet, the existing technology relies on, at best, a manual estimation of force by the person compressing the bullet/powder,

The inventor recognizes that improved accuracy can be obtained by determining an amount of force is being applied to the rod and therefore the powder charge. A disadvantage of a conventional loading rod is that is can provide inconsistent compression of the powder charge. This results in extreme variations in muzzle velocity, and degraded accuracy.

A purpose of my design is to accurately measure the compression force being applied to the powder charge when seating a bullet in a muzzle loading rifle barrel. I found that compressing the powder charge with equal force on every loading sequence improves accuracy when target shooting or hunting.

### BRIEF DESCRIPTION OF THE DRAWINGS

In the Drawings:

FIG. 1 shows the parts of an embodiment;

FIG. 2 shows a close up of the measuring scale;

FIG. 3 shows a dissembled embodiment;

FIG. 4 shows an electronic scale embodiment; and

FIG. 5 shows using a torque meter.

### DETAILED DESCRIPTION

The present application describes a traditional solid loading rod that includes a compression measuring device that measures the amount of force being pressed against the loading road. In one embodiment, the solid rod portion 89 of my loading rod is about 26″ long and is sized to fit down the barrel of a muzzle loading rifle. The solid rod is slightly smaller in diameter than the inside of the barrel.

In operation, a powder charge placed in the barrel of the muzzle loading rifle. A bullet is placed on the powder charge. An end 105 of the loading rod has a concave end intended to contact the convex end of the bullet. When downward force is applied to the rod, the bullet compresses the bullet against the powder charge. A force measuring device that is loaded in the loading rod measures the amount of force being pressed against the bullet and powder charge.

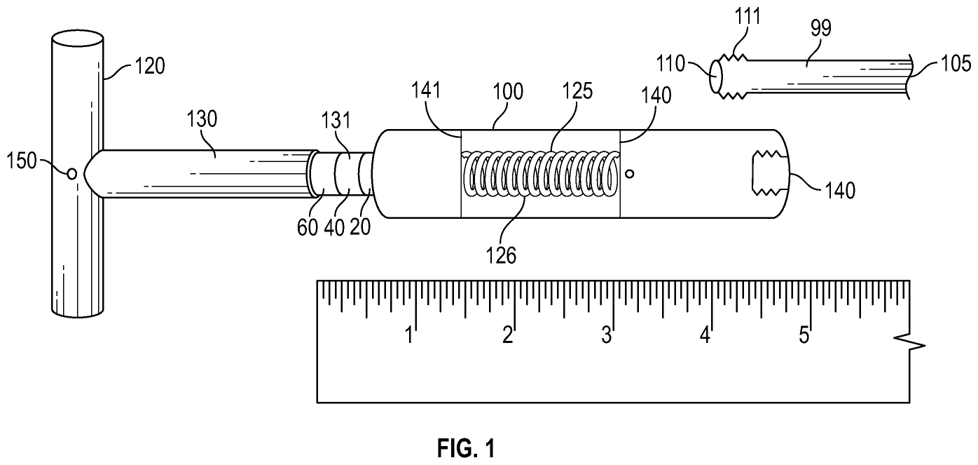

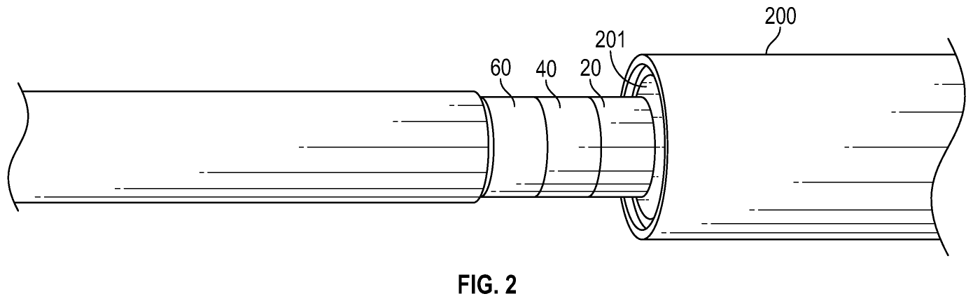

FIG. 1 shows the embodiment, where the loading rod 99 has a first concave end 105 for pressing the bullet. The opposite end 110 of the loading rod screws into the force measuring loading tool 100. The force measuring loading tool 100 has a “T” shaped handle 120. The tool includes a telescopic structure 125 approximately 5″ long that has a force measuring part configured to measure the force applied to the bullet. In the embodiment, the force measuring part includes a coil spring 126 pressed between first and second stop surfaces 140, 141 inside the telescopic structure. The coil spring 126 has an outer diameter at each end that presses against the respective stop surface. A first end of the coil spring biases against the loading rod 99. A moving rod 130 has an end that presses against the second end of the coil spring 126. The other end of the moving rod has a “T” handle 120, attached to the moving rod by an Allen bolt 150.

Graduations 131 on the moving rod 130 are calibrated in pounds (LBS.). The amount of downward force being applied to the moving rod compresses the coil spring 125 and the applied LBS of force being applied by the other end of the coil spring are visible on the graduated scale 131. The graduations can be determined by using a specific spring in the structure, calibrating the amount of movement required to create a specific number of pounds of force, and determining how to write the graduations based on the specific amount of force needed.

The construction of my loading rod incorporates a traditional solid loading rod threaded 111 on its exposed end 110 to attach to corresponding threads 140 in the end of the force measuring loading tool 100.

In an embodiment, the coil spring 126 fits inside inner surface of body tube 200. A threaded retainer cap 201 holds the spring inside those inner surfaces.

The body tube contains the coil spring and the moving rod that acts as a plunger, sliding into the inner surfaces of the body tube 200 against the coil spring and is secured by a threaded cap. The movement of the plunger is displayed as a compression force as the plunger is compressed against the coil spring.

In operation, the loading rod 99 is used in a similar manner to a solid loading rod. The person loading the rifle pours the measured powder charge into the barrel. The proper bullet is inserted base 105 first into the barrel to press the surface 105 against the bullet. The loading rod 99 is then inserted into the barrel pressed against the bullet, while attached to the force measuring loading tool. Applying moderate downward pressure pushes the bullet down the barrel until it contacts the powder charge. Once the bullet is in contact with the powder charge firmly pulling down on the “T” handle 120 will create a compression value in pounds visible on the plunger shaft scale 131 of the force measuring loading tool. The user can select a compression force and test the results of that compression force. The forces selected for any loading operation is easily repeatable on subsequent shots by duplicating the force reading on the plunger scale. The rifle will be loaded in this manner for every shot. The inventor found that maintaining a consistent compression of the powder charge before every shot is a key element in achieving maximum consistent accuracy from any muzzle loading rifle.

An embodiment describes measuring the compressive force in pounds (LBS) applied to the rod after the muzzle loading bullet has been seated on top of the powder charge in the barrel of any muzzle loading rifle. The number of pounds is determined by calibration. However, a consistent loading pressure can be maintained using any other kind of marking—for example, any other gradation, such as g/kg, or just numbers, such as 1, 2, 3, can be used to set the force, since repeatability may be as important as actual numerical values.

An optimal amount of force needed to achieve maximum accuracy from a muzzle loading rifle will require testing different compression force values. Once the optimum force value is determined, recreating that force for subsequent loading operation is easily achieved using the scale located on the plunger shaft.

The parts can be made of any materials, such as wood, fiberglass, carbon fiber, aluminum , steel, ceramic or composite material.

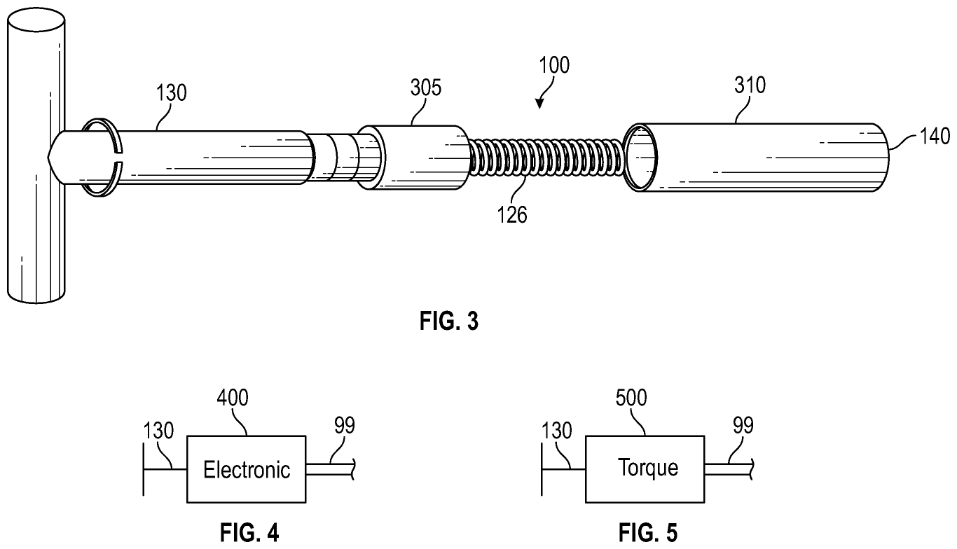

FIG. 3 illustrates an exploded view of the loading device, including the handle portion 130, the telescoping device 100 including the spring 126 between the two parts 305, 310 that are moveable relative to one another, and its end 140 which connects to the loading rod.

In alternative embodiments, the force value can be measured using an electronic stress gauge or strain gauge 400 mounted in the tube as shown in FIG. 4, or a mechanical torque gauge 500 as shown in FIG. 5. Electronic or mechanical gauges can be set for a specific force value and can signal the user by tactile or audible method when that value was achieved. However, the analog embodiment may be preferred since it uses only two moving mechanical parts to measure and display the force value.

A significant new feature of my invention is the addition of a force measuring device to a traditional solid loading rod. Having the ability to quantitatively measure the compression force on the powder charge in a muzzle loading rifle has never existed before.

In an embodiment, the compression force is displayed on the device in a range from 25-75 lbs., is easily repeatable and takes no extra time when loading the rifle.

An embodiment provides a way to easily measure the compression force applied to the bullet/powder in any muzzle loading rifle and duplicate that compression force on subsequent loadings for maximum accuracy. An embodiment contains no batteries or electronic devices and it is unaffected by water, heat or cold. The telescopic structure is removeable from the solid rod for easier transport and storage. Removing the telescopic structure of my loading rod allows the solid portion of the rod to be used as a traditional solid loading rod if desired.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A bullet loading device comprising:
a bullet packing structure, having a first end shaped for packing a bullet into a barrel of a rifle, said bullet packing structure including a cylindrical rod and being of a size that enables the bullet packing structure to fit within the barrel of the rifle;
a handle; and
a force sensing device, connected between the handle and the bullet packing structure, and measuring the amount of force applied by the handle to the bullet packing structure.

2. The device as in claim 1, wherein the force sensing device includes a telescopic device having moving parts that move relative to one another by an amount based on the force applied from the handle.

3. The device as in claim 2, wherein the force sensing device includes a spring, and a gauge that gauges an amount of movement of the moving parts that move relative to one another, the gauge being calibrated to display an amount of force.

4. The device as in claim 2, wherein the moving parts include a first rod that fits inside inner surfaces of a second tube, and a spring between the first rod and the second tube.

5. The device as in claim 1, wherein the force sensing device is formed by a spring.

6. The device as in claim 1, wherein the force sensing device is formed by an electronic strain gauge.

7. The device as in claim 1, wherein the force sensing device is formed by a mechanical torque gauge.

9. The device as in claim 1, wherein the bullet packing device attaches to the force sensing device by screwing onto the force sensing device.

10. The device as in claim 3, wherein the gauge is calibrated to display pounds of force.

11. The device as in claim 1, wherein the bullet packing structure, has a first end shaped for packing a bullet into a barrel of a rifle muzzleloading rifle.
